(19) United States
(12) Patent Application Publication
(10) Pub. No.: US 2023/0222721 A1
(43) Pub. Date: Jul. 13, 2023

(54) AVATAR GENERATION IN A VIDEO COMMUNICATIONS PLATFORM

(71) Applicant: Zoom Video Communications, Inc., San Jose, CA (US)

(72) Inventors: Wenyu Chen, Singapore (SG); Chichen Fu, San Jose, CA (US); Guozhu Hu, Hangzhou City (CN); Qiang Li, Hangzhou (CN); Wenhao Li, Hangzhou (CN); Wenchong Lin, Hangzhou (CN); Bo Ling, San Jose, CA (US); Gengdai Liu, Singapore (SG); Geng Wang, Hangzhou (CN); Kai Wei, Hangzhou (CN); Yian Zhu, San Jose, CA (US)

(21) Appl. No.: 17/589,771

(22) Filed: Jan. 31, 2022

(30) Foreign Application Priority Data
Jan. 13, 2022 (CN) 202210036647.4

(51) Int. Cl. G06T 13/40; G06V 10/70; G06V 40/16; G06T 17/20; G06T 19/20; H04L 65/403; H04L 65/60

(52) U.S. Cl. CPC G06T 13/40; G06V 10/70; G06V 40/176; G06T 17/20; G06T 19/20; H04L 65/403; H04L 65/60; G06T 2200/08; G06T 2219/2021; G06T 2210/44; G06T 2200/24

(57) ABSTRACT

Methods, systems, and apparatus, including computer programs encoded on computer storage media relate to a method for generating an avatar within a video communication platform. The system may receive a selection of an avatar model from a group of one or more avatar models. The system receives a first video stream and audio data of a first video conference participant. The system analyzes image frames of the first video stream to determine a group of pixels representing the first video conference participant. The system determines a plurality of facial expression parameter associated with the determined group of pixels. Based on the determined plurality of facial expression parameter values, the system generates a first modified video stream depicting a digital representation of the first video conference participant in an avatar form.

### FIELD

This application relates generally to video communications, and more particularly, to systems and methods for avatar generation in a video communications platform.

### SUMMARY

The appended claims may serve as a summary of this application.

### BRIEF DESCRIPTION OF THE DRAWINGS

FIG. 1A is a diagram illustrating an exemplary environment in which some embodiments may operate.

FIG. 1B is a diagram illustrating an exemplary computer system with software and/or hardware modules that may execute some of the functionality described herein.

FIG. 2 is a diagram illustrating an exemplary environment in which some embodiments may operate.

FIG. 3 is a diagram illustrating an exemplary avatar model and rendered digital representation in avatar form.

FIG. 4 is a flow chart illustrating an exemplary method that may be performed in some embodiments.

FIG. 5 is a flow chart illustrating an exemplary method that may be performed in some embodiments.

FIG. 6 illustrates an exemplary user interface according to one embodiment of the present disclosure.

FIG. 7 illustrates an exemplary user interface according to one embodiment of the present disclosure.

FIG. 8 illustrates an exemplary user interface according to one embodiment of the present disclosure.

FIG. 9 is a diagram illustrating an exemplary computer that may perform processing in some embodiments.

### DETAILED DESCRIPTION OF THE DRAWINGS

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

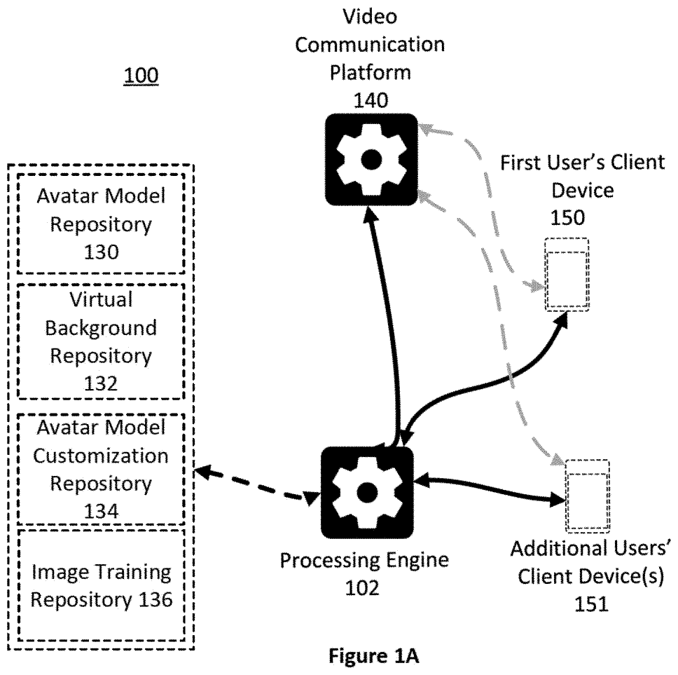

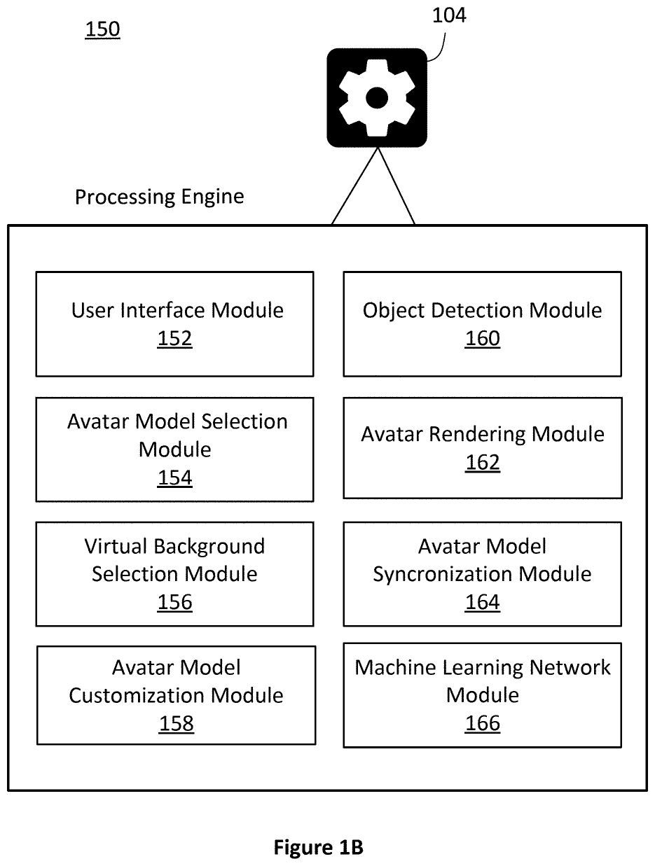

FIG. 1A is a diagram illustrating an exemplary environment in which some embodiments may operate. In the exemplary environment 100, a first user's client device 150 and one or more additional users' client device(s) 151 are connected to a processing engine 102 and, optionally, a video communication platform 140. The processing engine 102 is connected to the video communication platform 140, and optionally connected to one or more repositories (e.g., non-transitory data storage) and/or databases, including an avatar model repository 130, virtual background repository 132, an avatar model customization repository 134 and/or an image training repository for training a machine learning network. One or more of the databases may be combined or split into multiple databases. The first user's client device 150 and additional users' client device(s) 151 in this environment may be computers, and the video communication platform server 140 and processing engine 102 may be applications or software hosted on a computer or multiple computers which are communicatively coupled via remote server or locally.

The exemplary environment 100 is illustrated with only one additional user's client device, one processing engine, and one video communication platform, though in practice there may be more or fewer additional users' client devices, processing engines, and/or video communication platforms. In some embodiments, one or more of the first user's client device, additional users' client devices, processing engine, and/or video communication platform may be part of the same computer or device.

In an embodiment, processing engine 102 may perform the methods 400, 500 or other methods herein and, as a result, provide for avatar generation in a video communications platform. In some embodiments, this may be accomplished via communication with the first user's client device 150, additional users' client device(s) 151, processing engine 102, video communication platform 140, and/or other device(s) over a network between the device(s) and an application server or some other network server. In some embodiments, the processing engine 102 is an application, browser extension, or other piece of software hosted on a computer or similar device or is itself a computer or similar device configured to host an application, browser extension, or other piece of software to perform some of the methods and embodiments herein.

In some embodiments, the first user's client device 150 and additional users' client devices 151 may perform the methods 400, 500, or other methods herein and, as a result, provide for avatar generation in a video communications platform. In some embodiments, this may be accomplished via communication with the first user's client device 150, additional users' client device(s) 151, processing engine 102, video communication platform 140, and/or other device(s) over a network between the device(s) and an application server or some other network server.

The first user's client device 150 and additional users' client device(s) 151 may be devices with a display configured to present information to a user of the device. In some embodiments, the first user's client device 150 and additional users' client device(s) 151 present information in the form of a user interface (UI) with UI elements or components. In some embodiments, the first user's client device 150 and additional users' client device(s) 151 send and receive signals and/or information to the processing engine 102 and/or video communication platform 140. The first user's client device 150 may be configured to perform functions related to presenting and playing back video, audio, documents, annotations, and other materials within a video presentation (e.g., a virtual class, lecture, video conference, webinar, or any other suitable video presentation) on a video communication platform. The additional users' client device(s) 151 may be configured to viewing the video presentation, and in some cases, presenting material and/or video as well. In some embodiments, first user's client device 150 and/or additional users' client device(s) 151 include an embedded or connected camera which is capable of generating and transmitting video content in real time or substantially real time. For example, one or more of the client devices may be smartphones with built-in cameras, and the smartphone operating software or applications may provide the ability to broadcast live streams based on the video generated by the built-in cameras. In some embodiments, the first user's client device 150 and additional users' client device(s) 151 are computing devices capable of hosting and executing one or more applications or other programs capable of sending and/or receiving information. In some embodiments, the first user's client device 150 and/or additional users' client device(s) 151 may be a computer desktop or laptop, mobile phone, video phone, conferencing system, or any other suitable computing device capable of sending and receiving information. In some embodiments, the processing engine 102 and/or video communication platform 140 may be hosted in whole or in part as an application or web service executed on the first user's client device 150 and/or additional users' client device(s) 151. In some embodiments, one or more of the video communication platform 40, processing engine 102, and first user's client device 150 or additional users' client devices 151 may be the same device. In some embodiments, the first user's client device 150 is associated with a first user account on the video communication platform, and the additional users' client device(s) 151 are associated with additional user account(s) on the video communication platform.

In some embodiments, optional repositories can include one or more of: a user account avatar model repository 130, virtual background repository 132 and avatar model customization repository 134. The avatar model repository may store and/or maintain avatar models for selection and use with the video communication platform 140. The virtual background repository 132 may store and/or maintain virtual backgrounds for selection and use with the communication platform 140. In some embodiments, virtual background repository 132 may include selectable background images and/or video files that may be selected as a background for a selected avatar. The avatar model customization repository 134 may include customizations, style, coloring, clothing, facial feature sizing and other customizations made be a user to a particular avatar.

Video communication platform 140 comprises a platform configured to facilitate video presentations and/or communication between two or more parties, such as within a video conference or virtual classroom. In some embodiments, video communication platform 140 enables video conference sessions between one or more users.

FIG. 1B is a diagram illustrating an exemplary computer system 150 with software and/or hardware modules that may execute some of the functionality described herein. Computer system 150 may comprise, for example, a server or client device or a combination of server and client devices for avatar generation in a video communications platform.

The User Interface Module 152 provides system functionality for presenting a user interface to one or more users of the video communication platform 140 and receiving and processing user input from the users. User inputs received by the user interface herein may include clicks, keyboard inputs, touch inputs, taps, swipes, gestures, voice commands, activation of interface controls, and other user inputs. In some embodiments, the User Interface Module 152 presents a visual user interface on a screen. In some embodiments, the user interface may comprise audio user interfaces such as sound-based interfaces and voice commands.

The Avatar Model Selection Module 154 provides system functionality for selection of an avatar model to be used for presenting the user in an avatar form during video communication in the video communication platform 140.

The Virtual Background Module 156 provides system functionality for selection of a virtual background to be used as a background when presenting the user in an avatar form during video communication in the video communication platform 140.

The Avatar Model Customization Module 158 provides system functionality for the customization of features and/or the presented appearance of an avatar. For example, the Avatar Model Customization Module 158 provides for the selection of attributes that may be changed by a user. For example, changes to an avatar model may include hair customization, facial hair customization, glasses customization, clothing customizations, hair, skin and eye coloring changes, facial feature sizing and other customizations made be the user to a particular avatar. The changes made to the particular avatar are stored or saved in the avatar model customization repository 134.

The Object Detection Module 160 provides system functionality for determining an object within a video stream. For example, the Object Detection Module 160 may evaluate frames of a video stream and identify the head and/or body of a user. The Object Detection Module may extract or separate pixels representing the user from surrounding pixel representing a background of the user.

The Avatar Rendering Module 162 provides system functionality for rendering a 3-dimensional avatar based on a received video stream of a user. For example, in one embodiment the Object Detection Module 160 identifies pixels representing the head and/or body of a user. These identified pixels are then processed by the Avatar Rendering Module in conjunction with a selected avatar model. The Avatar Rendering Module 162 generates a digital representation of the user in an avatar form. The Avatar Rendering Module generates a modified video stream depicting the user in an avatar form (e.g., a 3-dimensional digital representing based on a selected avatar model). Where a virtual background has been selected, the modified video stream includes a rendered avatar overlayed on selected first virtual background.

The Avatar Model Synchronization Module 164 provides system functionality for synchronizing or transmitting avatar models from an Avatar Modeling Service. The Avatar Modeling Service may generate or store electronic packages of avatar models for distribution to various client devices. For example, a particular avatar model may be updated with a new version of the model. The Avatar Model Synchronization Module handles the receipt and storage of the electronic packages on the client device of the distributed avatar models from the Avatar Modeling Service.

The Machine Learning Network Module 164 provides system functionality for use of a machine learning network trained to evaluate image data and determine facial expression parameters for facial expression found in the image data. The determined facial expression parameters are used to select blendshapes to morph or adjust a 3D mesh-based model.

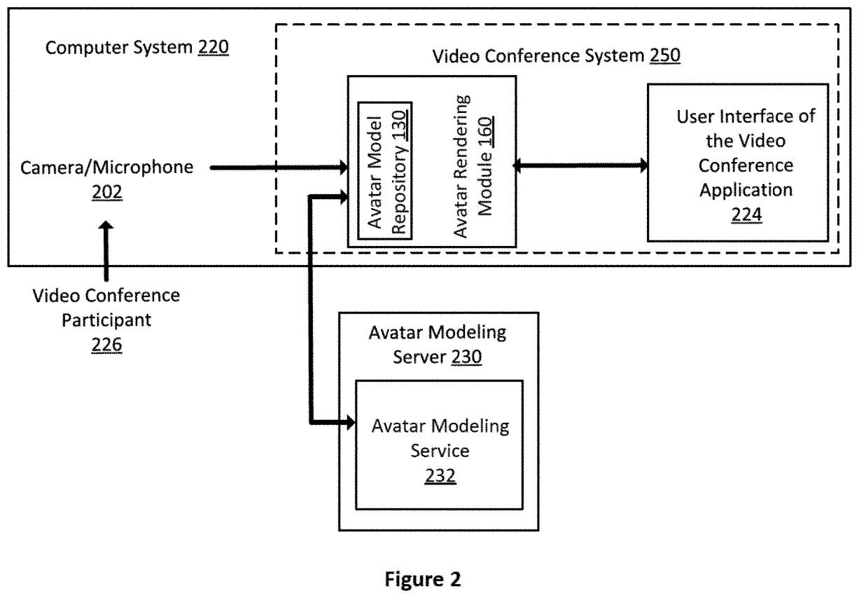

FIG. 2 illustrates one or more client devices that may be used to participate in a video conference and/or virtual environment. In one embodiment, during a video conference, a computer system 220 (such a desktop computer or a mobile phone) is used by a Video Conference Participant 226 (e.g., a user) to communication with other video conference participants. A camera and microphone 202 of the computer system 202 captures video and audio of the video conference participant 226. The Video Conference System 250 receives a video stream of the captured video and audio and is processed by the Video Conference System 250. Based on the received video stream, for a selected avatar model from the Avatar Model Repository 130, the Avatar Rendering Module 160 renders or generates a modified video stream depicting a digital representation of the Video Conference Participant 226 in an avatar form. The modified video stream may be presented via a User Interface of the Video Conference Application 224.

In some embodiment, the Video Conference System 250 may receive electronic packages of updated 3D avatar models which are then stored in the Avatar Model Repository 130. An Avatar Modeling Server 230 may be in electronic communication with the Computer System 220. An Avatar Modeling Service 232 may generate new or revised three-dimensional (3D) avatar models. The Computer System 220 communicates with the Avatar Modeling Service to determine whether any new or revised avatar models are available. Where a new or revised avatar model is available, the Avatar Modeling Services 232 transmits an electronic packaging containing the new or revised avatar model to the Computer System 220.

In some embodiments, the Avatar Modeling Service 232 transmits an electronic package to the Computer System 220. The electronic package may include a head mesh of a 3D avatar model, a body mesh of the 3D avatar model and a body skeleton having vector or other geometry information for use in moving the body of the 3D avatar model, model texture files, multiple blendshapes, and other data. In some embodiments, the electronic package includes a blendshape for each of the different or unique facial expression that may be identified by the machine learning network as described below. In one embodiment, the package may be transmitted as a glTF file format.

In some embodiments, the system may determine multiple different facial expressions or actions values for an evaluated image. The system 100 may include in the package, a corresponding blendshape for each of the multiple different facial expressions that may be identified by the system. The system may use the different blendshapes to adjust or deform the 3D mesh-based model (e.g., the head mesh model) when rendering a digital representation of a Video Conference Participant 226 in avatar form.

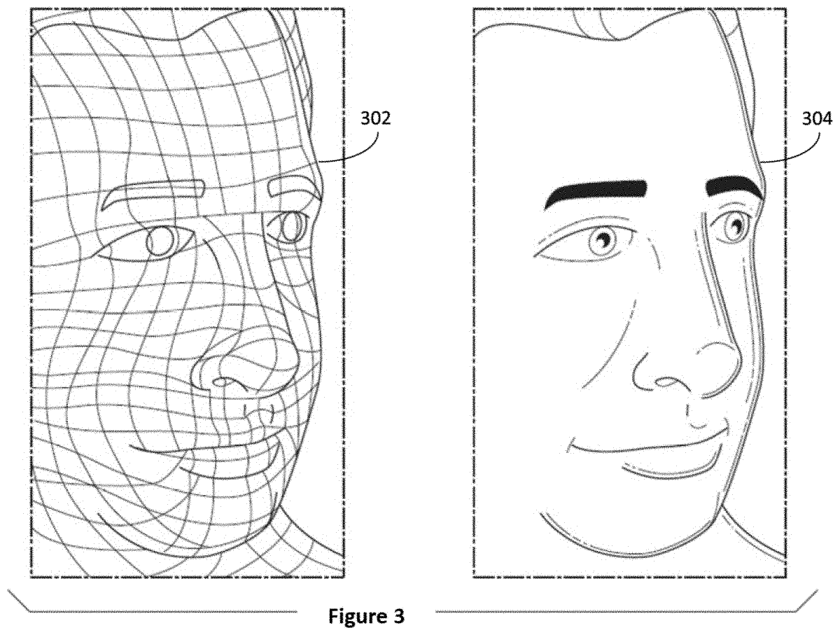

FIG. 3 is a diagram illustrating an exemplary avatar model 302 and a rendered digital representation 304 in avatar form. The system 100 generates from a 3D mesh-based model 302, a digital representation of a video conference participant in an avatar form 304. The avatar model 302 may be a mesh-based 3D model 302. In some embodiments, a separate avatar head mesh model and a separate body mesh model may be used. The 3D head mesh model may be rigged to use different blendshapes for natural expressions. In one embodiment, the 3D head mesh model may be rigged to use at least 51 different blendshapes. Also, the 3D head mesh model may have an associated tongue model. The system 100 may detect tongue out positions in an image and render the avatar model depicting a tongue out animation.

Different types of 3D mesh-based models may be used with the system 100. In some embodiments, a 3D mesh-based model may be based on three-dimensional facial expression (3DFE) models (such as Binghamton University (BU)-3DFE (2006), BU-4DFE (2008), BP4D-Spontaneous (2014), BP4D+(2016), EB+(2019), BU-EEG (2020) 3DFE, ICT-FaceKit, and/or a combination thereof). The foregoing list of 3D mesh-based models is meant to be illustrative and not limiting. One skilled in the art would appreciate that other 3D mesh-based model types may be used with the system 100.

In some embodiments, the system 100 may use Facial Action Coding System (FACS) coded blendshapes for facial expression and optionally other blendshapes for tongue out expressions. FACS is a generally known numeric system to taxonomize human facial movements by the appearance of the face. In one embodiment, the system 100 uses 3D mesh-based avatar models rigged with at least multiple FACS coded blendshapes. The system 100 may use FACS coded blendshapes to deform the geometry of the 3D mesh-based model (such as a 3D head mesh) to create various facial expressions.

In some embodiments, the system 100 uses a 3D morphable model (3DMM) to generate rigged avatar models. For example, the following 3DMM may be used to represent a user's face with expressions: v=m+Pa+Bw, where m is the neutral face, P is the face shape basis and B is the blendshape basis. The neutral face and face shape basis are created from 3D scan data (3DFE/4DFE) using non-rigid registration techniques.

In some embodiments, the system 100 may receive multiple scans of a user's face to generate a personalized 3D head mesh model representing the user. For example, the system 100 may create an image dataset with multiple face scans of images depicting a user's face (e.g., approximately 200 scans). Each face scan may be represented as a shape vector. Some unsymmetric registrations out of the face scans may be selected due to inaccurate 3D landmarks, which are then deformed for symmetric shapes. The system 100, for example, may generate approximately −230 high quality face or head meshes. A customized head mesh of a user may then be packaged with associated bendshapes, and the electronic package transmitted to the client's device.

The face shape basis P may be computed using principal component analysis (PCA) on the face meshes. PCA will result in principal component vectors which correspond to the features of the image data set. The blendshape basis B may be derived from the open-source project ICT-FaceKit. The ICT-FaceKit provides a base topology with definitions of facial landmarks, rigid and morphable vertices. The ICT-FaceKit provides a set of linear shape vectors in the form of principal components of light stage scan data registered to a common topology.

Instead of a deformation transfer algorithm, which gives unreliable results if the topologies of source and target meshes are distinct, in some embodiments the system 100 may use non-rigid registration to map the template face mesh to an ICT-FaceKit template. The system 100 may then rebuild blendshapes simply using barycentric coordinates. In some embodiment, to animate the 3D avatar, only expression blendshape weights w would be required (i.e., detected facial expressions).

In some embodiments, the 3D mesh-based models (e.g., in the format of FBX, OBJ, 3ds Max 2012 or Render Vray 2.3 with a textures format of PNG diffuse) may be used as the static avatars rigged using linear blend skinning with joints and bones.

The blendshapes may be used to deform facial expressions. Blendshape deformers may be used in the generation of the digital representation. For example, blendshapes may be used to interpolate between two shapes made from the same numerical vertex order. This allows a mesh to be deformed and stored in a number of different positions at once.

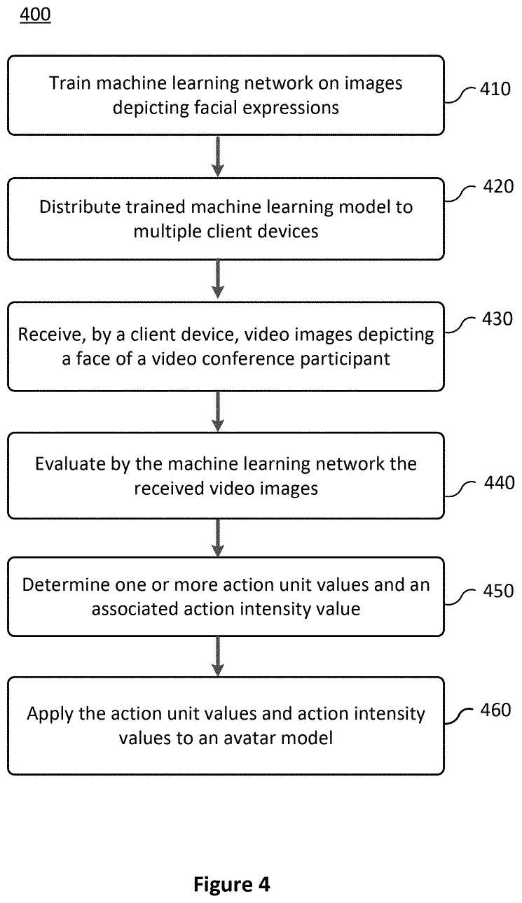

FIG. 4 is a flow chart illustrating an exemplary method 400 that may be performed in some embodiments. A machine learning network may be trained to evaluate video images and determine facial expression parameter values of a person's face depicted in the image. In some embodiments, the system 100 may use machine learning techniques such as deep machine learning, learning-capable algorithms, artificial neural networks, hierarchical models and other artificial intelligence processes or algorithms that have been trained to perform image recognition tasks, such as performing machine recognition of specific facial features in imaging data of a person. Based on the characteristics or features recognized by the machine learning network on the image data, the system 100 may generate parameters for application to the 3D mesh-based models.

In step 410, a machine learning network may be trained on sets of images to determine facial expression parameter values. The training sets of images depict various facial expressions and are labeled with a corresponding action number and an intensity value. For example, the machine learning network may be trained using multiple images of actions depicting a particular actions unit value and optionally an intensity value for the associated action. In some embodiment, the system 100 may train the machine learning network by supervised learning which involves sequentially generating outcome data from a known set of image input data depicting a facial expression and the associated action unit number and an intensity value.

Table 1 below illustrates some examples of action unit (AU) number and the associated facial expression name:

TABLE 1

| AU Number | FACS Name |
|---|---|
| 0 | Neutral face |
| 1 | Inner brow raiser |
| 3 | Outer brow raiser |
| 4 | Brow lowerer |
| 43 | Eyes Closed |
| 51 | Head turn left |
| 52 | Head turn right |
| 61 | Eyes turn left |
| 62 | Eyes turn right |
| 66 | Cross-eye |

In some embodiment, the machine learning network may be trained to evaluate an image to identify one or more FACS action unit values. The machine learning network may identify and output a particular AU number for a facial expression found in the image. In one embodiment, the machine learning network may identify at least 51 different action unit values of an image evaluated by the machine learning network.

In some embodiments, the machine learning network may also be trained to provide an intensity score of a particular action unit. For example, the machine learning network may be trained to provide an associated intensity score of A-E, where A is the lowest intensity and E is the highest intensity of the facial action (e.g., A is trace action, B is a slight action, C is a marked or pronounced action D is a severe or extreme action, and E is a maximum action). In another example, the machine learning network may be trained to output a numeric value ranging from zero to one. The number zero indicates a neutral intensity, or that the action value for a particular facial feature is not found in the image. The number one indicates a maximum action of the facial feature. The number 0.5 may indicate a marked or pronounced action.

In step 420, an electronic version or copy the trained machine learning network may be distributed to multiple client devices. For example, the trained machine learning network may be transmitted to and locally stored on client devices. The machine learning network may be updated and further trained from time to time and the machine learning network may be distributed to a client device 150, 151, and stored locally.

In step 430, a client device 150, 151 may receive video images of a video conference participant. Optionally, the video images may be pre-processed to identify a group of pixels depicting the head and optionally the body of the video conference participant.

In step 440, each frame from the video (or the identified group of pixels) is input into the local version of the machine learning network stored on the client device. The local machine learning evaluates the image frames (or the identified group of pixels). The system 100 evaluates the image pixels through an inference process using a machine learning network that has been trained to classify one or more facial expressions and the expression intensity in the digital images. For example, the machine learning network may receive and process images depicting a video conference participant.

At step 450, the machine learning network determines facial expression values such as one or more action unit values with an associated action intensity value. In some embodiments, only an action unit value is determined. For example, an image of a user may depict that the user's eyes are closed, and the user's head is slightly turned to the left. The trained machine learning network may output two pairs of action unit values and corresponding intensity values of 43, 1 and 51, 0.5. Action unit value 43 would indicate that the eyes are closed, and the intensity values 1 would maximum action (i.e., eyes closed all the way). Action unit value 51 would indicate head turned to the left, and the intensity value 0.5 would indicate pronounced action (i.e., head turned half-way to the left).

At step 460, the system 100 applies the determined action unit value and corresponding intensity value pairs to an avatar model. Blendshapes of the avatar model are then selected based on the determined action unit values. A 3D animation of the avatar model is then rendered using the selected blendshapes. The selected blend shapes morph or adjust the mesh geometry of the avatar model.

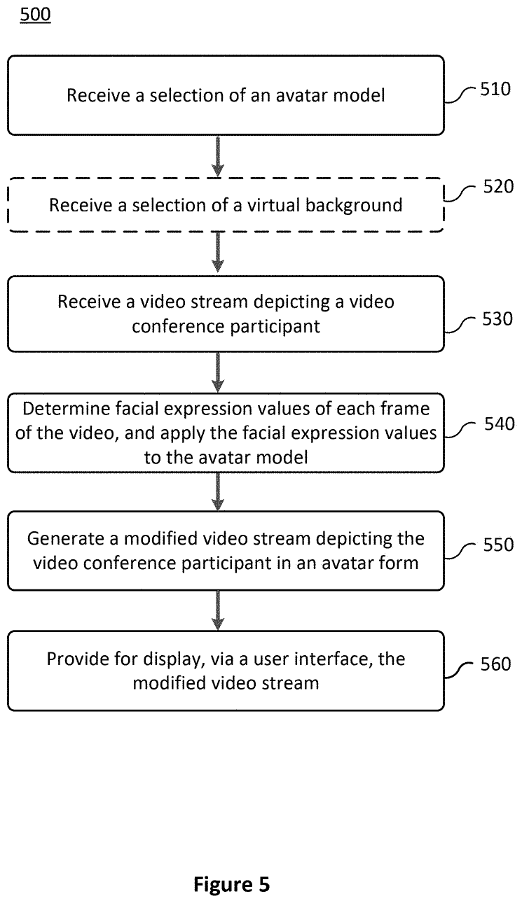

FIG. 5 is a flow chart illustrating an exemplary method 500 that may be performed in some embodiments. In some embodiments, the system 100 provides for processing and translating received a video stream of a video conference participant into a modified video stream of the video conference participant in an avatar form.

At step 510, the system 100 receives the selection of an avatar model. In one embodiment, once selected, the system 100 may be configured to use the same avatar model each time the video conference participant participates in additional video conferences.

At step 520, the system 100 optionally receives the selection of a virtual background to be used with the avatar model. In one embodiment, an avatar model has a default virtual background that is used with the avatar model. In other embodiments, a user may select a virtual background to be used with the avatar model.

At step 530, the system 100 receives a video stream depicting imagery of a first video conference participant, the video stream includes multiple video frames and audio data. In some embodiments, the video stream is captured by a video camera attached or connected to the first video conference participant's client device. The video stream may be received at the client device, the video communication platform 140, and/or processing engine 102.

In some embodiments, the system 100 provides for determining a pixel boundary between a video conference participant in a video and the background of the participant. The system 100 retains the portion of the video depicting the participant and removes the portion of the video depicting the background. In one mode of operation, when generating the avatar, the system 100 may replace the background of the participant with the selected virtual background. In another mode of operation, when generating the avatar, the system 100 may use the background of the participant, with the avatar overlaying the background of the participant.

At step 540, the system 100 determines facial expression values of each frame of the video stream and applies the facial expression values to the avatar model. In some embodiments, the system 100 determines facial expression values based on evaluation of image frames of depicting the video conference participant.

At step 550, the system 100 generates or renders a modified video stream depicting a digital representation of the video conference participant in an animated avatar form. The system 100 may use the determined facial expression values to select one or more blendshape and then apply the one or more blendshape at an associated intensity level to morph the 3D-mesh model. The determined facial expression values are applied to the 3D mesh-based avatar model to generate a digital representation of the video conference participant in an avatar form. As a result, the facial expressions of the animated avatar then closely mirror the real-world physical facial expressions expressed by the video conference participant.

At step 560, the system 100 provides for display, via a user, the modified video stream. The modified video stream depicting the video conference participant in an avatar form may be transmitted to other video conference participants for display on their local device.

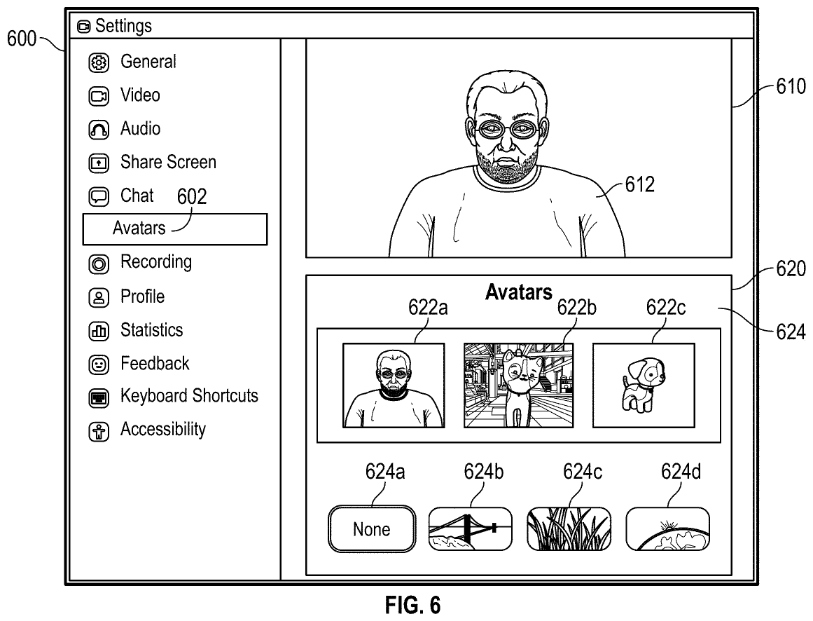

FIG. 6 illustrates an exemplary user interface 600 according to one embodiment of the present disclosure. In some embodiments, the user interface 600 may provide a control or icon for the selection of Avatars 602. In response to receiving an input, the user interface 600 may display a portion 624 of the user interface available depicting on or more available avatars (622a, 6222b, 6223). The avatars 622a, 622b, 622c may be displayed as a still image and/or may be displayed as a moving avatar. Avatar 622a represents a custom generated 3D-mesh model of the user. Avatars 622b and 622c represent 3D-mesh models of different animal avatars.

In some embodiments, the user interface portion 624 may also display available virtual backgrounds (625b, 624c, 624d) that may be used with an avatar. The user interface 600 may receive an input selection for a virtual background to be used with the virtual avatar. The selected virtual background is used when generating the modified video stream depicting the digital representation of the user in an avatar form. In some embodiments, the avatar has a default background that is used when generating the modified video stream depicting the digital representation of the user in avatar form (such as 622b). In other embodiments, no virtual background may be selected (624a). When no virtual background is selected, the avatar may be presented on the real background of the user as captured by the user's camera.

In some embodiments, when the system 100 cannot locate or identify the video participant's face in the received video stream, the system 100 omits the avatar from the modified video stream, and only the virtual background is depicted in the modified video stream. In other words, the animated avatar is no longer displayed in the video stream. For example, this mode of operation allows the system 100 to generate an avatar of a video participant when they are physically present, and their computer or mobile device camera obtains video images of the video participant. When the video conference participant steps out of view from their camera, then the system 100 would not generate that user's avatar and consequently not be generated or displayed to other video conference participants. This mode of operation indicates when a video participant may actively participate, and not just activate their avatar and the walking away from view of their computer or mobile device computer.

In some embodiments, a virtual background file may be a file such as a video file, an image files (e.g., a jpeg, gif, etc.), or any other type of graphics or multimedia file. In general, a virtual background file is of a file of any type that allows for the system 100 to present a still graphic image and/or a video image as a virtual background in conjunction with a user's video feed. The virtual background file may be stored on a file system, computer system memory, either in local storage or in a server-based storage system or database. The system 100 retrieves the virtual background file to be used by the system 100 as a virtual background while a user is engaged in video communications with one or more other users.

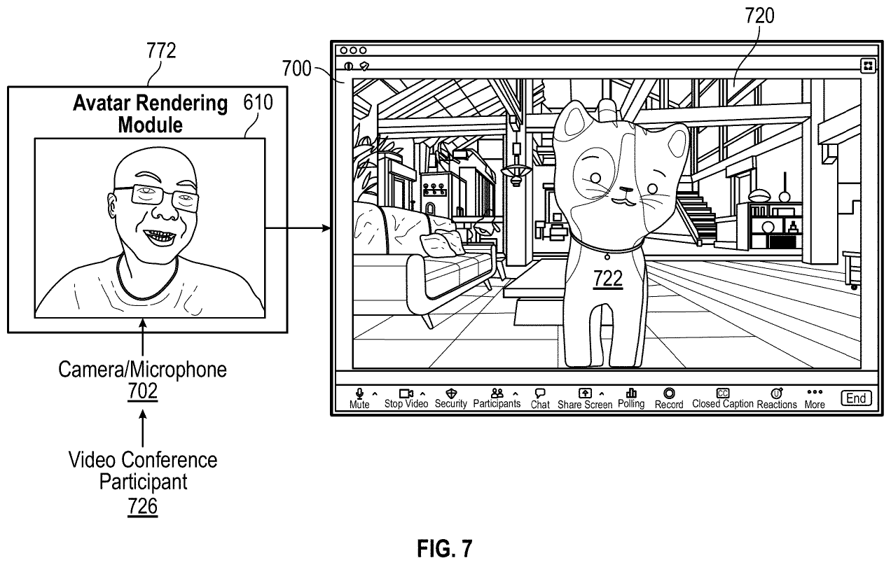

FIG. 7 illustrates an exemplary user interface 700 according to one embodiment of the present disclosure. This example illustrates a received video stream being translated to a digital representation of the Video Conference Participant 726 in an avatar form 722. A video stream and audio data of a Video Conference Participant (e.g., a user) is captured using a camera and microphone 702. The video stream may include both video images and audio data. In one embodiment, the Avatar Rendering Module 772 translates facial expressions of the user in the video stream to a rendered 3D avatar animation having similar facial expressions.

In some embodiments, the system 100 provides a 3D animation rendering module 772 (e.g., a animation redefining engine) which is configured to apply blendshapes to a 3D mesh-based avatar model. The system 100 may use a graphical processing unit (GPU) based rendering engine to render a 3D animation of the avatar 720. For example, when the system 100 receives an input from a user for the selection of an avatar for use in a video communication session, the system 100 may load into GPU memory the 3D mesh-based models, blendshapes, textures and other data that are packaged for a particular avatar model. The system 100 renders a digital representation of the video conference participant using the 3D model assets that have been loaded into GPU memory.

In one mode of operation, the system 100 also uses a rigged body and underlying skeletal structure to move the body at various predefined vertices or joints of the skeletal structure. Based on a determined head movement and intensity, the system 100 may apply a movement to the skeletal structure to generate an animated body movement of the rendered avatar. The system 100 may apply a weight value to the body movement based on the intensity of a detected head movement of the video conference participant. The weight values determine how much the head movement influences the body vertices. For example, an animation technique of linear landscaping may be used animate the body of the avatar.

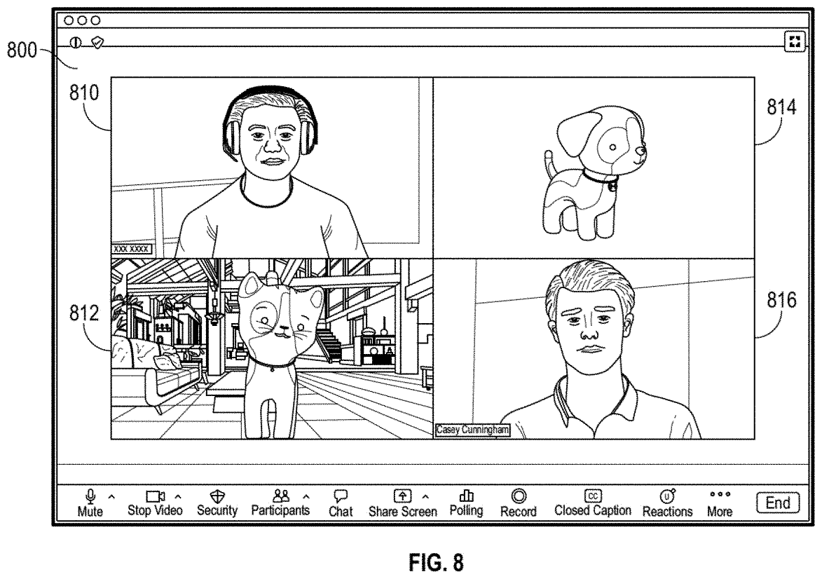

FIG. 8 illustrates an exemplary user interface according to one embodiment of the present disclosure. This example illustrates a video conference with multiple video conference participants. In this example, four video conference participant are communicating to each other via the video communications platform. Two of the participants are using an avatar 812, 814 and two of the participants are using normal video 810, 816.

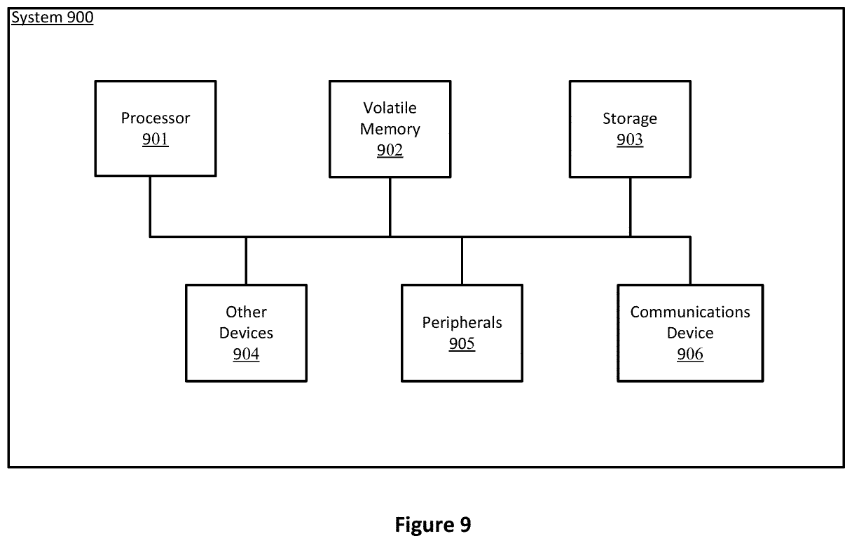

FIG. 9 is a diagram illustrating an exemplary computer that may perform processing in some embodiments. Exemplary computer 900 may perform operations consistent with some embodiments. The architecture of computer 900 is exemplary. Computers can be implemented in a variety of other ways. A wide variety of computers can be used in accordance with the embodiments herein.

Processor 901 may perform computing functions such as running computer programs. The volatile memory 902 may provide temporary storage of data for the processor 901. RAM is one kind of volatile memory. Volatile memory typically requires power to maintain its stored information. Storage 903 provides computer storage for data, instructions, and/or arbitrary information. Non-volatile memory, which can preserve data even when not powered and including disks and flash memory, is an example of storage. Storage 903 may be organized as a file system, database, or in other ways. Data, instructions, and information may be loaded from storage 903 into volatile memory 902 for processing by the processor 901.

The computer 900 may include peripherals 905. Peripherals 905 may include input peripherals such as a keyboard, mouse, trackball, video camera, microphone, and other input devices. Peripherals 905 may also include output devices such as a display. Peripherals 905 may include removable media devices such as CD-R and DVD-R recorders/players. Communications device 906 may connect the computer 1300 to an external medium. For example, communications device 906 may take the form of a network adapter that provides communications to a network. A computer 900 may also include a variety of other devices 904. The various components of the computer 900 may be connected by a connection medium such as a bus, crossbar, or network.

It will be appreciated that the present disclosure may include any one and up to all of the following examples.

Example 1: A computer-implemented method comprising: receiving a selection of an avatar model from a group of one or more avatar models; receiving a first video stream comprising multiple image frames of a first video conference participant; inputting at least a group of pixels of each of the multiple image frames into a trained machine learning network; identifying by the trained machine learning network, a plurality of facial expression parameter values associated with the multiple images; generating a first modified video stream by: based on the plurality of facial expression parameter values, morphing a three-dimensional head mesh of the selected avatar model, and rendering a digital representation of the first video conference participant in an avatar form; and providing for display, in a user interface of a video conferencing environment, the first modified video stream.

Example 2: The method of Example 1, wherein the morphing the three-dimensional head mesh comprises the operations of: selecting one or more blendshapes based on the generated plurality of facial expression parameter values; and applying the one or more blendshapes to modify a mesh geometry of the selected avatar model.

Example 3. The method of any one of Examples 1-2, further comprising: receiving a second modified video stream of a video conference participant, the second modified video stream comprising a digital representation of a second video conference participant in an avatar form; and providing for display, in a user interface of the video conferencing environment, the second modified video stream.

Example 4. The method of any one of Examples 1-3, further comprising: receiving a selection of a first virtual background for use with the selected avatar model; and wherein the first modified video stream depicts the digital representation of the first video conference participant in avatar form overlayed on the selected first virtual background.

Example 5. The method of any one of Examples 1-4, further comprising: determining that the first video conference participant is not being captured in the first video stream; and changing the first modified video stream to depict the selected first virtual background without the digital representation of the first video conference participant in an avatar form; and providing for display, in the user interface of a video conferencing environment, the changed first modified video stream.

Example 6. The method of any one of Examples 1-5, wherein the plurality of facial expression parameter associated include one or more action unit values and associated intensity values.

Example 7. The method of Examples 1-6, wherein the plurality of facial expression parameter values comprises at least 51 different action unit values.

Example 8. A non-transitory computer readable medium that stores executable program instructions that when executed by one or more computing devices configure the one or more computing devices to perform operations comprising: receiving a selection of an avatar model from a group of one or more avatar models; receiving audio data and a first video stream comprising multiple image frames of a first video conference participant; inputting at least a group of pixels of each of the multiple image frames into a trained machine learning network; identifying by the trained machine learning network, a plurality of facial expression parameter values associated with the multiple images; generating a first modified video stream by: based on the plurality of facial expression parameter values, morphing a three-dimensional head mesh of the selected avatar model, and rendering a digital representation of the first video conference participant in an avatar form; and providing for display, in a user interface of a video conferencing environment, the first modified video stream.

Example 9. The non-transitory computer readable medium of Example 8, wherein morphing the three-dimensional head mesh comprises the operations of: selecting one or more blendshapes based on the generated plurality of facial expression parameter values; and applying the one or more blendshapes to modify a mesh geometry of the selected avatar model.

Example 10. The non-transitory computer readable medium of any one of Examples 8-9, further comprising the operations of: receiving a second modified video stream of a video conference participant, the second modified video stream comprising a digital representation of a second video conference participant in an avatar form; and providing for display, in a user interface of the video conferencing environment, the second modified video stream.

Example 11. The non-transitory computer readable medium of any one of Examples 8-10 further comprising the operations of: receiving a selection of a first virtual background for use with the selected avatar model; and wherein the first modified video stream depicts the digital representation of the first video conference participant in avatar form overlayed on the selected first virtual background.

Example 12. The non-transitory computer readable medium of any one of Examples 8-11, further comprising the operations of: determining that the first video conference participant is not being captured in the first video stream; and changing the first modified video stream to depict the selected first virtual background without the digital representation of the first video conference participant in an avatar form; and providing for display, in the user interface of a video conferencing environment, the changed first modified video stream.

Example 13. The non-transitory computer readable medium of any one of Examples 8-12, wherein the plurality of facial expression parameter associated include one or more action unit values and associated intensity values.

Example 14. The non-transitory computer readable medium of any one of Examples 8-13, wherein the plurality of facial expression parameter values comprises at least 51 different action unit values.

Example 15. A system comprising one or more processors configured to perform the operations of: receiving a selection of an avatar model from a group of one or more avatar models; receiving audio data and a first video stream comprising multiple image frames of a first video conference participant; inputting at least a group of pixels of each of the multiple image frames into a trained machine learning network; identifying by the trained machine learning network, a plurality of facial expression parameter values associated with the multiple images; generating a first modified video stream by: based on the plurality of facial expression parameter values, morphing a three-dimensional head mesh of the selected avatar model, and rendering a digital representation of the first video conference participant in an avatar form; and providing for display, in a user interface of a video conferencing environment, the first modified video stream.

Example 16. The system of Example 15, further wherein morphing the three-dimensional head mesh comprises the operations of: selecting one or more blendshapes based on the generated plurality of facial expression parameter values; and applying the one or more blendshapes to modify a mesh geometry of the selected avatar model.

Example 17. The system of any one of Examples 15-16, further comprising the operations of: receiving a second modified video stream of a video conference participant, the second modified video stream comprising a digital representation of a second video conference participant in an avatar form; and providing for display, in a user interface of the video conferencing environment, the second modified video stream.

Example 18. The system of any one of Examples 15-17, further comprising the operations of: receiving a selection of a first virtual background for use with the selected avatar model; and wherein the first modified video stream depicts the digital representation of the first video conference participant in avatar form overlayed on the selected first virtual background.

Example 19. The system of any one of Examples 15-18, further comprising the operations of: determining that the first video conference participant is not being captured in the first video stream; and changing the first modified video stream to depict the selected first virtual background without the digital representation of the first video conference participant in an avatar form; and providing for display, in the user interface of a video conferencing environment, the changed first modified video stream.

Example 20. The system of any one of Examples 15-19, wherein the plurality of facial expression parameter associated include one or more action unit values and associated intensity values.

Example 21. The system of any one of Examples 15-20, wherein the plurality of facial expression parameter values comprises at least 51 different action unit values.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A computer-implemented method comprising:
receiving a selection of an avatar model from a group of one or more avatar models;
receiving a first video stream comprising multiple image frames of a first video conference participant;
inputting at least a group of pixels of each of the multiple image frames into a trained machine learning network;
determining by the trained machine learning network, a plurality of facial expression parameter values associated with the multiple images;
generating a first modified video stream by:
based on the plurality of facial expression parameter values, morphing a three-dimensional head mesh of the selected avatar model; and
rendering a digital representation of the first video conference participant in an avatar form; and
providing for display, in a user interface of a video conferencing environment, the first modified video stream.

2. The method of claim 1, wherein the morphing a three-dimensional head mesh comprises:
selecting one or more blendshapes based on the determined plurality of facial expression parameter values; and
applying the selected one or more blendshapes to modify a mesh geometry of the selected avatar model.

3. The method of claim 1, further comprising:
receiving a second modified video stream of a video conference participant, the second modified video stream comprising a digital representation of a second video conference participant in an avatar form; and
providing for display, in a user interface of the video conferencing environment, the second modified video stream.

4. The method of claim 1, further comprising:
receiving a selection of a first virtual background for use with the selected avatar model; and
wherein the first modified video stream depicts the digital representation of the first video conference participant in avatar form overlayed on the selected first virtual background.

5. The method of claim 4, further comprising:
determining that the first video conference participant is not being captured in the first video stream; and
changing the first modified video stream to depict the selected first virtual background without the digital representation of the first video conference participant in an avatar form; and
providing for display, in the user interface of a video conferencing environment, the changed first modified video stream.

6. The method of claim 1 wherein the plurality of facial expression parameter associated include one or more action unit values and associated intensity values.

7. The method of claim 1, wherein the plurality of facial expression parameter values comprises at least 51 different action unit values.

8. A non-transitory computer readable medium that stores executable program instructions that when executed by one or more computing devices configure the one or more computing devices to perform operations comprising:
receiving a selection of an avatar model from a group of one or more avatar models;
receiving a first video stream comprising multiple image frames of a first video conference participant;
inputting at least a group of pixels of each of the multiple image frames into a trained machine learning network;
determining by the trained machine learning network, a plurality of facial expression parameter values associated with the multiple images;
generating a first modified video stream by:
based on the determined plurality of facial expression parameter values, morphing a three-dimensional head mesh of the selected avatar model; and
rendering a digital representation of the first video conference participant in an avatar form; and
providing for display, in a user interface of a video conferencing environment, the first modified video stream.

9. The non-transitory computer readable medium of claim 8, wherein the operation of morphing a three-dimensional head mesh comprises the operations of:
selecting one or more blendshapes based on the determined plurality of facial expression parameter values; and
applying the one or more blendshapes to modify a mesh geometry of the selected avatar model.

10. The non-transitory computer readable medium of claim 8, further comprising the operations of:
receiving a second modified video stream of a video conference participant, the second modified video stream comprising a digital representation of a second video conference participant in an avatar form; and
providing for display, in a user interface of the video conferencing environment, the second modified video stream.

11. The non-transitory computer readable medium of claim 8, further comprising the operations of:
receiving a selection of a first virtual background for use with the selected avatar model; and
wherein the first modified video stream depicts the digital representation of the first video conference participant in avatar form overlayed on the selected first virtual background.

12. The non-transitory computer readable medium of claim 8, further comprising the operations of:
determining that the first video conference participant is not being captured in the first video stream; and
changing the first modified video stream to depict the selected first virtual background without the digital representation of the first video conference participant in an avatar form; and
providing for display, in the user interface of a video conferencing environment, the changed first modified video stream.

13. The non-transitory computer readable medium of claim 8, wherein the plurality of facial expression parameter associated include one or more action unit values and associated intensity values.

14. The non-transitory computer readable medium of claim 8, wherein the plurality of facial expression parameter values comprises at least 51 different action unit values.

15. A system comprising one or more processors configured to perform the operations of:
receiving a selection of an avatar model from a group of one or more avatar models;
receiving a first video stream comprising multiple image frames of a first video conference participant;
inputting at least a group of pixels of each of the multiple image frames into a trained machine learning network;
determining by the trained machine learning network, a plurality of facial expression parameter values associated with the multiple image frames;
generating a first modified video stream by:
based on the determined plurality of facial expression parameter values, morphing a three-dimensional head mesh of the selected avatar model; and
rendering a digital representation of the first video conference participant in an avatar form; and
providing for display, in a user interface of a video conferencing environment, the first modified video stream.

16. The system of claim 15, wherein morphing a three-dimensional head mesh comprises:
selecting one or more blendshapes based on the generated plurality of facial expression parameter values; and
applying the one or more blendshapes to modify a mesh geometry of the selected avatar model.

17. The system of claim 15, further comprising the operations of:
receiving a second modified video stream of a video conference participant, the second modified video stream comprising a digital representation of a second video conference participant in an avatar form; and
providing for display, in a user interface of the video conferencing environment, the second modified video stream.

18. The system of claim 15, further comprising the operations of:
receiving a selection of a first virtual background for use with the selected avatar model; and
wherein the first modified video stream depicts the digital representation of the first video conference participant in avatar form overlayed on the selected first virtual background.

19. The system of claim 18, further comprising the operations of:
determining that the first video conference participant is not being captured in the first video stream; and
changing the first modified video stream to depict the selected first virtual background without the digital representation of the first video conference participant in an avatar form; and
providing for display, in the user interface of a video conferencing environment, the changed first modified video stream.

20. The system of claim 18, wherein the plurality of facial expression parameter associated include one or more action unit values and associated intensity values.
